(19) United States
(12) Patent Application Publication
(10) Pub. No.: US 2006/0189753 A1
(43) Pub. Date: Aug. 24, 2006

(54) Cores made from unplasticized polyvinyl butyral for wound plastic sheets

(76) Inventor: Mark Y. Wagner, Fayetteville, NC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/061,080

(22) Filed: Feb. 18, 2005

(51) Int. Cl. C08F 8/00

(52) U.S. Cl. 525/61; 264/176.1

(57) ABSTRACT

The present invention is a shaped article suitable for winding plasticized polyvinyl butyral sheeting to form a roll of said sheeting, wherein the shaped article consists essentially of unplasticized polyvinyl butyral. In another aspect, the present invention is a manufacturing process comprising the step of winding plasticized polyvinyl butyral onto a core of unplasticized polyvinyl butyral.

### BACKGROUND OF THE INVENTION

1. Field of the Invention

This invention relates to uses for polyvinyl butyral copolymers.

2. Description of the Prior Art

Plastic sheeting manufactured for use in large manufacturing processes is generally wound, stored and transported as rolls. The plastic sheeting is generally wound around a core so that winding and unwinding can be accomplished with ease and/or convenience at the manufacturers' and/or customers' site.

Polyvinyl butyral (PVB) plasticized sheeting is manufactured for use in, among other things, laminated safety glass. PVB is plasticized for use in most, if not all, of the applications in which it finds utility. Plasticized PVB is flexible and can be can be wound around conventional cores such as paper cores or cores made of acrylonitrile/butadiene/styrene (ABS) plastic. Use of cores made of these materials provides a source of contamination for the PVB sheeting, however.

Migration of plasticizer from the innermost layer of a roll to a paper core, for example, can be a problem if not managed properly. Likewise, chips of foreign plastic material can stick to the PVB. Use of ABS cores with PVB sheeting can pose problems resulting from a lack of adhesion of the PVB to the ABS core, such as slippage. Also, used ABS or paper cores can be a problem for a PVB manufacturer or user when recycling, disposal, or storage is considered. For example, it can be desirable to take a used or unusable roll and core, or a used core, and recycle it along with scrap PVB. However, this is not possible with conventional ABS or paper cores.

It can be desirable to reduce, minimize, or eliminate the contamination of plasticized PVB sheeting by foreign material originating from the shipping core.

### SUMMARY OF THE INVENTION

In one aspect, the present invention is a shaped article suitable for functioning as a core for winding thermoplastic sheeting onto in order to form a roll of said sheeting around said core, wherein the core consists essentially of unplasticized polyvinyl butyral (PVB).

In another aspect, the present invention is a process comprising the step of forming an unplasticized PVB core by extrusion of unplasticized PVB to form a shaped article suitable for use as a core for winding PVB sheeting.

### BRIEF DESCRIPTION OF THE DRAWINGS

FIG. 1 is an isometric view of a core of the present invention having a tubular cylindrical shape.

FIG. 2 is a side view of the core.

FIG. 3 is an end view of the core.

FIG. 4 is a view showing a cutout of section A-A, which shows the rounded edge of the core.

### DETAILED DESCRIPTION OF THE INVENTION

In one embodiment, the present invention is a shaped article, or core, consisting essentially of unplasticized polyvinyl butyral (PVB). The article can be any shape that can allow for take up (winding), unwinding, and doffing (that is, cutting rolled sheet and winding it onto a new core) of thermoplastic sheeting, such as for example plasticized, PVB sheeting in either a continuous or a non-continuous manner to form a roll of the PVB sheeting. It is important that the core provide such capability because any benefit gained by reducing contamination or otherwise allowing for more convenient recycle of the core would be lost if the roll does not wind and/or unwind continuously.

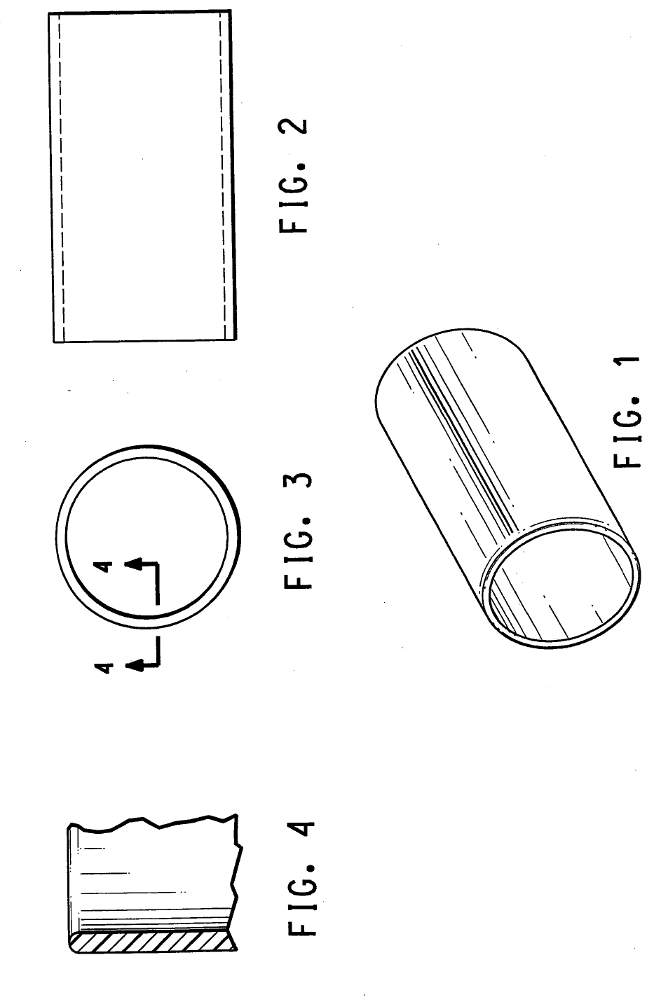

While there are many variations that can be used in a design of a core, the shape of core of the present invention can be any that is conventional for cores performing a similar purpose. It is preferable that the core be cylindrical in shape, having an inner diameter (ID) and an outer diameter (OD) that together define the thickness of the core wall as depicted in FIG. 1.

The inner and outer diameters are selected to accommodate the mandrel and provide for the winding/unwinding operations that are essential for using PVB rolls. Without strictly limiting the scope of the present invention, generally the inner diameter is preferably at least 3 inches, and more preferably at least about 6 inches. Not all process operations utilizing PVB rolls use the same processing equipment. Due to various size requirements of mandrels that are to be accommodated by the cores of the present invention, any diameter core that can be made by known methods on conventional process equipment is considered within the scope of the present invention.

The wall thickness can be varied depending upon the strength that is desirable, or required, to support the load of the PVB roll. The heavier the load placed on the core by the roll, the thicker the wall of the core that is required to avoid sagging in the roll. It has been discovered that in the present application, due to greater stiffness of unplasticized PVB versus ABS conventional core material, a PVB core of the present invention can comprise a thinner wall to obtain the same level of performance as thicker ABS cores, for example. Any wall thickness can be used in the practice of the present invention depending on the load requirements. However, it can be preferred to use PVB cores having a wall thickness of at least about 0.150 inches. More preferably, depending upon the load requirements placed upon the core by the roll, a PVB core can have a wall thickness of at least 0.200 inches.

The core can be made in any length that is appropriate for the size and width of sheeting that it is to hold. In one embodiment of the present invention, a PVB core can be made to lengths that exceed that length required for a particular sheeting application, and the length of the core can be cut to the desirable length. Generally, a core can be made or cut to any length that will provide support to a roll of sheeting. For example, a core can be made or cut to lengths of from at least 1 inch up to any length that can be made on conventional manufacturing equipment. Preferably a roll is made or cut to lengths from at least about 18 inches to about 144 inches, more preferably from at least about 24 inches up to about 132 inches, and most preferably from about 24 inches up to about 127 inches. Any length or any individual point within these ranges is considered within the contemplated scope of the present invention. The length of the core is dependent only upon the width of the sheeting to be wound around the core, and the limitations of the manufacturing equipment.

PVB cores of the present invention can be made by any method conventionally known for fabricating shaped articles from plastic materials. For example, PVB cores of the present invention can be manufactured by extrusion or by compaction. In the practice of the present invention, it is preferred that the core is extruded. Conventional extrusion techniques can be used to fabricate cores of the present invention.

Cores of the present invention are obtained from unplasticized PVB resin. Plasticized PVB can be commercially obtained, for example, from E.I. DuPont de Nemours and Company (DuPont). Unplasticized PVB can be obtained from commercial PVB manufacturers. Unplasticized PVB can be extruded at temperatures above about 150° C. In a preferred embodiment, a core of the present invention is extruded at a temperature of from about 180 to about 250° C. In a particularly preferred embodiment, unplasticized PVB is extruded at a temperature of from about 180 to about 210° C. to obtain a core of the present invention. Temperature limits are selected such that the unplasticized PVB flows efficiently through the extruder, while at the same time is not degraded by too high of a heat history.

By unplasticized it is meant that the PVB core comprises less than about 5 parts per hundred (pph) of a plasticizer added prior to fabrication of the core. Preferably the core comprises less than about 3 pph of plasticizer, and more preferably less than 1 pph. Most preferably the core comprises no plasticizer added prior to its fabrication. While it is not contemplated as part of the present invention, it is expected that at least some plasticizer can be transferred from a plasticized PVB roll to the unplasticized core. The occurrence of such transfer after fabrication of the core does not remove the core from the bounds of the presently claimed invention.

Thermoplastic sheeting can be wound around a core of the present invention for storage, shipping or for further use in a manufacturing process. Any type of plastic sheeting that is suitable for winding onto a core can be wound onto a core of the present invention. For example, suitable thermoplastic polymers can be polymers selected from the group consisting of: polyethylenes; polypropylenes; ethylene copolymers, including ethylene acid copolymer and salts derivable therefrom, ethylene vinyl acetate (EVA) copolymers, and the like; polyesters; polyurethanes; polyvinylacetals; polyacetals; polyvinylchlorides; or composites thereof are plastic materials that can be formed into sheeting and wound around a core of the present invention.

In a particularly preferred embodiment of the present invention, plasticized PVB sheeting can be wound onto PVB that is rotated by a mandrel. Plasticized PVB can be particularly preferred for several reasons. First, contamination of the sheeting coming from the roll would not present a significant issue if the core and the wound material comprise the same material, thereby eliminating extra procedural steps that may be required to minimize such contamination. Second, there is a natural affinity of the sheeting to the core, thereby facilitating the winding process as plasticized PVB adheres better to the surface of the unplasticized PVB core. Another advantage is that the core can be recycled with other PVB and used in other applications, which provides an improvement in the product life cycle of the core.

Sheeting is wound onto a core of the present invention in the same manner as done with other cores used for the same purpose. An appropriately sized mandrel can rotate continuously until a desirable length of sheeting is wound onto the core to form a roll. The sheeting can be cut and doffed to a second core for storage, shipping, or further processing to make laminate articles, for example.

### EXAMPLES

The Examples are for illustrative purposes only, and are not intended to limit the scope of the invention. In the Examples, unplasticized PVB flake material was obtained according to known and conventional procedures.

### Example 1

PVB flake was extruded into pellets in a vacuum extruder. The feed pellets thus obtained were extruded through a second extruder and continuously formed into a core having a tubular shape. The resin pellets were extruded at a temperature of 204 C through a water-cooled die to obtain a 36-inch cylindrical core having an ID of 6.10 inches and a wall thickness of 150 mils. Plasticized tinted PVB sheeting (1660 ft) was wound onto the core, then doffed to a second PVB core. The PVB core did not slip or present other process problems. No transfer to the core of ink from the tint or plasticizer was apparent.

### Example 2

The procedures of Example 1 were repeated except that a core having an ID of 6.04 with the same OD was extruded to obtain a core wall thickness of 180 mils.

### Example 3

The procedures of Example 1 were repeated except that a core having an ID of 6.01 with the same OD was extruded to obtain a core wall thickness of 195 mils.

### Examples 4-6

Examples 1-3 were repeated except that ethylene glycol 3-hexanoate was used as the plasticizer, with the observed results similar to those obtained with the previous examples.

### Example 7

A PVB core is cut and added to a recycle batch of PVB. The core is granulated along with the recycled plasticized roll of sheeting using conventional grinders and granulators. The core chips are blended and extruded along with the plasticized PVB to form sheeting, and the chips are plasticized in the extrusion process.

What is claimed is:

1. A shaped article suitable for functioning as a core for winding thermoplastic sheeting onto in order to form a roll of said sheeting around said core, wherein the core consists essentially of unplasticized polyvinyl butyral (PVB).

2. An article comprising a core and thermoplastic sheeting wound around said core, the core consisting essentially of unplasticized polyvinylbutyral.

3. The article of claim 2 wherein the thermoplastic sheeting comprises a thermoplastic polymer selected from the group consisting of: polyethylenes; polypropylenes; ethylene copolymers; polyesters; polyurethanes; polyvinylacetals; polyacetals; polyvinylchlorides; or composites thereof.

4. The article of claim 3 wherein the sheeting comprises polyvinyl butyral (PVB).

5. A process comprising the step of forming an unplasticized PVB core by extrusion of unplasticized PVB to form a shaped article suitable for use as a core for winding PVB sheeting.

6. The process of claim 5 wherein the core is extruded at a temperature of from about 180° C. to about 210° C.

7. The process of claim 6 wherein the process further comprises the step of winding plasticized PVB onto the core of unplasticized PVB.

8. The process of claim 7 wherein the core has an inner diameter of at least about 3 inches.
